(19) United States
(12) Patent Application Publication
(10) Pub. No.: US 2018/0337009 A1
(43) Pub. Date: Nov. 22, 2018

(54) BACKLIGHT KEYBOARD WITH BACKLIGHT ADJUSTING FUNCTION, BACKLIGHT ADJUSTING SYSTEM AND BACKLIGHT ADJUSTING METHOD

(71) Applicant: Primax Electronics Ltd., Taipei (TW)

(72) Inventors: TIEN-YU YEH, Taipei (TW); CHE-WEI YANG, Taipei (TW)

(21) Appl. No.: 15/814,814

(22) Filed: Nov. 16, 2017

(30) Foreign Application Priority Data
May 19, 2017 (TW) 106116685

(51) Int. Cl. H01H 13/83; G06F 3/02; H05B 37/02

(52) U.S. Cl. CPC H01H 13/83; H01H 2219/016; H05B 37/02; G06F 3/0202

(57) ABSTRACT

The present invention provides a backlight keyboard with a backlight adjusting function, a backlight adjusting system and a backlight adjusting method. The backlight keyboard includes plural keys and a backlight module. The backlight module includes a light guide plate and plural light-emitting elements. The backlight adjusting method includes the following steps. Firstly, the plural light-emitting elements emit light beams, so that plural backlight zones corresponding to the plural keys are formed on the light guide plate. Then, respective luminance values of the plural backlight zones are detected. Then, an overall average luminance value of the plural backlight zones is calculated. If a preset criterion is satisfied, brightness levels of the light-emitting elements corresponding to the backlight zones are adjusted according to the luminance value of the backlight zones and the overall average luminance value.

### FIELD OF THE INVENTION

The present invention relates to a backlight keyboard with a backlight adjusting function, a backlight adjusting system and a backlight adjusting method, and more particularly to a technology for adjusting, controlling or compensating luminance of a luminous keyboard in order to solve the problem of non-uniform illumination or non-uniform transmittance.

### BACKGROUND OF THE INVENTION

As known, computers such as desktop computer (e.g., personal computers) or notebook computers become essential tools in our daily lives. Moreover, keyboards are important input devices of computers. Via the keyboards, users can input characters or perform control operations. Generally, a keyboard comprises plural keys. These keys are located at specified positions. Moreover, many electronic devices or electrical operation devices are equipped with keys that are used as operation interfaces of performing various designated functions.

For allowing users to perform the input and control operations, the keys of the keyboard are specially designed. That is, the key is returned to its original position in response to a single depressing action, and a triggering signal is generated in response to the depressing action. In addition to the keys, the keyboard device further comprises indication elements or backlight elements with illuminating functions according to the practical requirements.

Generally, the keyboard device with the illuminating function is a combination of the conventional keyboard device and an illumination module. The illumination modules are classified into two types, i.e., a top-view illumination module and a side-view illumination module. The top-view illumination module comprises a light emitting diode (LED) under a keycap of the corresponding key. The light emitting diode is used as a backlight source from the backside of the keycap. The keycap is made of light-transmissible material. The light beam is transmitted through the keycap. Consequently, the character/symbol printed on the keycap is recognizable or a special imaging effect is produced.

As mentioned above, the light emitting diode of the top-view illumination module is located under the corresponding key. Consequently, the light emitting diode is electrically connected with a membrane circuit or a membrane structure. Moreover, the cost of the light emitting diode is high, and the backlight efficacy is influenced by the position of the light emitting diode under the keycap.

The side-view illumination module is a backlight module that is combined with a backside of the keyboard device. The backlight module usually comprises at least one light bar and a light guide plate. The at least one light bar is located beside at least one lateral side of the light guide plate. Each light bar comprises plural light emitting diodes. The light emitting diodes emit light beams to the light guide plate. These light beams are transferred through the light guide plate so as to be formed as a backlight-type planar light source. Moreover, the light guide plate further comprises microstructures or reflecting structures for facilitating transferring the light beams more uniformly. Consequently, the planar light source can be generated.

Since the light beams emitted by the side-view illumination module are formed as the backlight-type planar light source, the light beams are transmitted through the keycaps of the key more uniformly. However, because of the design of the key structure, the backlight keyboard with the side-view illumination module still has some drawbacks. For example, the material of the keycap or the position-returning element for returning the keycap may influence the transmittance of the key. Since the transmittance is not uniform, some keys of the keyboard device are too bright or some keys are too dark.

Conventionally, the light guide plate of the backlight module is produced by using a screen printing process. For adjusting the backlight efficacy of the light guide plate to comply with a specified keyboard device, it is necessary to re-design the light guide plate by using another screen printing process. After the light guide plate is produced, the light guide plate is combined with the keyboard device and the combination of the light guide plate and the keyboard is tested. That is, if the original backlight keyboard has the problem of non-uniform transmittance, the original backlight keyboard cannot be effectively improved by the existing technology. Moreover, the conventional backlight keyboard is not cost-effective and the competiveness of the conventional backlight keyboard is not satisfied.

### SUMMARY OF THE INVENTION

The present invention provides a backlight keyboard with a backlight adjusting function, a backlight adjusting system and a backlight adjusting method. An object of the present invention is to adjust, control or compensate the illuminating condition of the luminous keyboard in order to solve the problem of non-uniform illumination or non-uniform transmittance. Moreover, according to the practical requirements, the illuminating status is changed. Consequently, the use flexibility is enhanced. When compared with the conventional backlight keyboard, the backlight keyboard of the present invention is beneficial because of the backlight adjustment.

In accordance with an aspect of the present invention, there is provided a backlight adjusting method for a backlight keyboard. The backlight keyboard includes a keyboard portion and a backlight module. The keyboard portion includes plural keys. The backlight module includes a light guide plate and plural light-emitting elements. The plural light-emitting elements are located beside at least two lateral sides of the light guide plate. The backlight adjusting method includes the following steps. Firstly, an initiation process is performed to allow the plural light-emitting elements to emit light beams, so that plural backlight zones corresponding to the plural keys are formed on the light guide plate. Then, a detecting process is performed to detect respective luminance values of the plural backlight zones. Then, a calculating process is performed to calculate an overall average luminance value of the plural backlight zones. Then, an adjusting process is performed. If a preset criterion is satisfied, brightness levels of the light-emitting elements corresponding to the backlight zones are adjusted according to the luminance values of the backlight zones and the overall average luminance value. Moreover, the detecting process, the calculating process and the adjusting process are repeatedly performed.

In accordance with another aspect of the present invention, there is provided a backlight keyboard with a backlight adjusting function. The backlight keyboard includes a keyboard portion and a backlight module. The keyboard portion includes plural keys. The backlight module is disposed on a backside of the keyboard portion, and includes a light guide plate and plural light-emitting elements. The plural light-emitting elements are located beside at least two lateral sides of the light guide plate. The plural light-emitting elements emit light beams in an initiation process, so that plural backlight zones corresponding to the plural keys are formed on the light guide plate. Moreover, respective luminance values of the plural backlight zones are detected in a detecting process, and an overall average luminance value of the plural backlight zones is calculated in a calculating process. If a preset criterion is satisfied, brightness levels of the light-emitting elements corresponding to the backlight zones are adjusted in an adjusting process according to the luminance values of the backlight zones and the overall average luminance value. The detecting process, the calculating process and the adjusting process are repeatedly performed.

In accordance with a further aspect of the present invention, there is provided a backlight adjusting system. The backlight adjusting system includes a backlight keyboard and a detecting machine. The backlight keyboard includes a keyboard portion and a backlight module. The backlight module is disposed on a backside of the keyboard portion. The keyboard portion includes plural keys. The detecting machine is applied to the backlight keyboard. The backlight module includes a light guide plate and plural light-emitting elements. The plural light-emitting elements are located beside at least two lateral sides of the light guide plate. The plural light-emitting elements emit light beams in an initiation process, so that plural backlight zones corresponding to the plural keys are formed on the light guide plate. Moreover, respective luminance values of the plural backlight zones are detected in a detecting process, and an overall average luminance value of the plural backlight zones is calculated in a calculating process. If a preset criterion is satisfied, brightness levels of the light-emitting elements corresponding to the backlight zones are adjusted in an adjusting process according to the luminance values of the backlight zones and the overall average luminance value. The detecting process, the calculating process and the adjusting process are repeatedly performed.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating the architecture of a backlight adjusting system according to an embodiment of the present invention;

FIG. 2 is a schematic top view illustrating the backlight keyboard of the backlight adjusting system according to the embodiment of the present invention;

FIG. 3 is a flowchart illustrating a backlight adjusting method according to an embodiment of the present invention; and

FIG. 4 is a schematic top view illustrating the backlight keyboard of the backlight adjusting system after the detecting process of the backlight adjusting method is completed.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

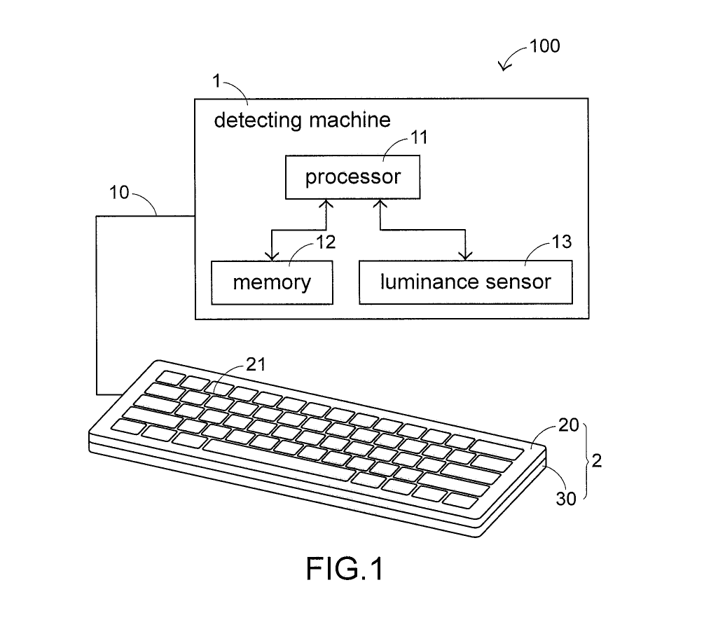

A backlight adjusting system according to an embodiment of the present invention will be described as follows. FIG. 1 is a schematic functional block diagram illustrating the architecture of a backlight adjusting system according to an embodiment of the present invention. The backlight adjusting system 100 comprises a backlight keyboard 2 and a detecting machine 1. According to the practical requirements, the way of establishing the electric connection between the backlight keyboard 2 and the detecting machine 1 may be different. Preferably but not exclusively, the electric connection between the backlight keyboard 2 and the detecting machine 1 is established through a universal serial bus (USB) transmission line 10.

An object of the present invention is to adjust, control or compensate the illuminating condition of the luminous keyboard in order to solve the problem of non-uniform illumination or non-uniform transmittance. Moreover, according to the practical requirements, the illuminating status is changed. Consequently, the use flexibility is enhanced. When compared with the conventional backlight keyboard, the backlight keyboard of the present invention is beneficial because of the backlight adjustment. The backlight adjusting method will be described in more details as follows.

In an embodiment, the detecting machine 1 comprises a processor 11, a memory 12 and a luminance sensor 13. The processor 11 is electrically connected with the memory 12 and the luminance sensor 13. The detecting machine 1 is applied to the backlight keyboard 2 for implementing the backlight adjusting function. Particularly, when a firmware component or a software component stored in the memory 12 is executed, the backlight adjusting method of the present invention is implemented and applied to the backlight keyboard 2. The luminance sensor 13 is a general luminance meter (or brightness meter). Moreover, the luminance sensor 13 is disposed on the backlight keyboard 2 in order to detect luminance values.

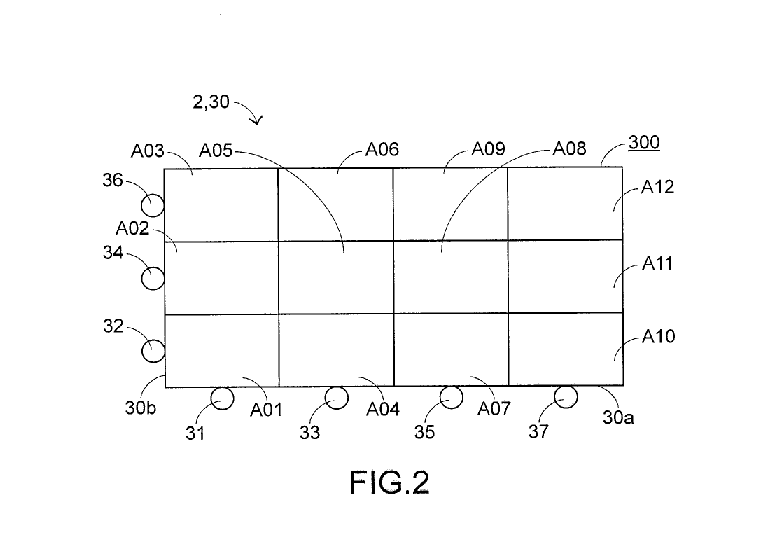

FIG. 2 is a schematic top view illustrating the backlight keyboard of the backlight adjusting system according to the embodiment of the present invention. Please refer to FIGS. 1 and 2. As shown in FIG. 1, the backlight keyboard 2 comprises a keyboard portion 20 and a backlight module 30. The backlight module 30 is disposed on a backside of the keyboard portion 20. For succinctness, the keyboard portion 20 is not shown in FIG. 2 and only the backlight module 30 is shown. The backlight module 30 comprises a light guide plate 300 and plural light-emitting elements 31˜37.

In this embodiment, the plural light-emitting elements 31˜37 are located beside two lateral sides 30a and 30b of the light guide plate 300. The plural light-emitting elements 31˜37 emit light beams to the light guide plate 300. These light beams are transferred through the light guide plate 300 so as to be formed as a backlight-type planar light source. Like the conventional technology, the light beams can be uniformly transferred within the light guide plate 300. Moreover, plural keys 21 of the keyboard portion 20 are made of light-transmissible material. Consequently, the light beams can be transmitted through the keys 21.

In this embodiment, the light-emitting elements 31, 33, 35 and 37 are discretely arranged beside the lateral side 30a at a regular spacing interval, and the light-emitting elements 32, 34 and 36 are discretely arranged beside the lateral side 30b at a regular spacing interval. When the light-emitting elements 31˜37 emit the light beams, plural backlight zones A01˜A12 in an array arrangement and corresponding to the plural keys 21 are formed on the light guide plate 300. It is noted that numerous modifications and alterations may be made while retaining the teachings of the invention. Generally, the number of the backlight zones A01˜A12 and the dimensions of the backlight zones A01˜A12 are relative to the arrangements of the light-emitting elements 31˜37. As the number of light-emitting elements is increased, the number of the backlight zones is increased and the size of each backlight zone is decreased. In an embodiment, one key is illuminated by many backlight zones. Alternatively, in another embodiment, many keys are illuminated by one backlight zone.

Like the conventional technology, the light guide plate 300 used in the present invention further comprises microstructures (not shown) for facilitating transferring the light beams more uniformly. In case that the light beams are not uniformly transmitted through some keys or some regions, it is not necessary to reinstall or replace the light guide plate 300. For example, the light-emitting elements 31˜37 are light emitting diodes (LEDs). By controlling the luminous power of the light-emitting elements 31˜37, the luminance value of at least one specified position of the light guide plate 300 is adjustable.

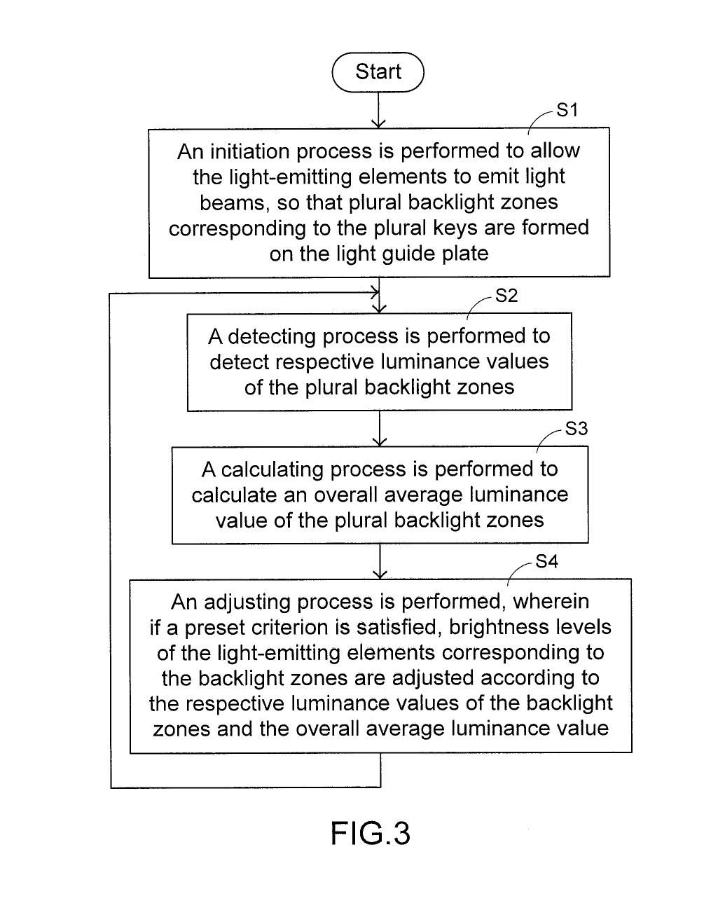

FIG. 3 is a flowchart illustrating a backlight adjusting method according to an embodiment of the present invention. Firstly, an initiation process is performed. Consequently, the light-emitting elements 31˜37 emit light beams and plural backlight zones A01˜A12 corresponding to the plural keys 21 are formed on the light guide plate 300 (Step S1). Then, a detecting process is performed to detect respective luminance values of the plural backlight zones A01˜A12 (Step S2). Then, a calculating process is performed to calculating an overall average luminance value of the plural backlight zones A01˜A12 (Step S3). Then, an adjusting process is performed. If a preset criterion is satisfied, brightness levels of the light-emitting elements corresponding to the backlight zones A01˜A12 are adjusted according to the respective luminance values of the backlight zones A01˜A12 and the overall average luminance value (Step S4). Then, the detecting process S2, the calculating process S3 and the adjusting process S4 are repeatedly performed.

In the backlight adjusting method of FIG. 3, the detecting machine 1 is employed to perform the backlight adjustment on the backlight keyboard 2. The backlight adjusting method may be used in the testing stage of the backlight keyboard 2 in a production line. Alternatively, the backlight adjusting method is used in a maintenance stage of the backlight keyboard 2 after the backlight keyboard 2 is produced.

Please also refer to FIGS. 1 and 2. In the initiation process S1, the backlight keyboard 2 is enabled to turn on the light-emitting elements 31˜37. Preferably, the light-emitting elements 31˜37 have the same model, structure and lighting form. That is, these light-emitting elements 31˜37 have the same bright level (e.g., B1) in the initiation process. In the detecting process S2, the luminance sensor 13 of the detecting machine 1 is used to detect the backlight zones A01˜A12. Consequently, the respective luminance values of the backlight zones A01˜A12 are obtained.

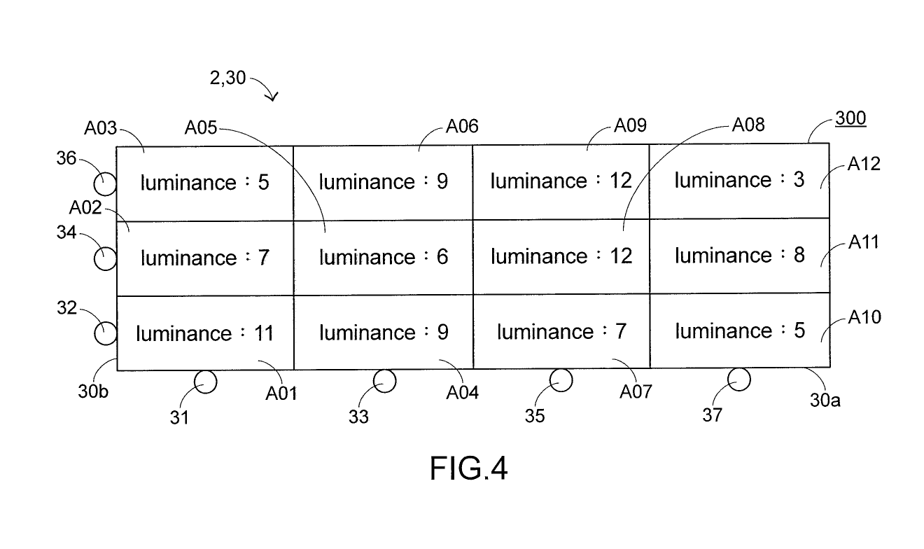

FIG. 4 is a schematic top view illustrating the backlight keyboard of the backlight adjusting system after the detecting process of the backlight adjusting method is completed. After the initiation process is completed, the light-emitting elements 31˜37 emit the light beams. Then, the detecting process is performed to detect the respective luminance values of the plural backlight zones A01˜A12. As previously described, the backlight zones may have non-uniform transmittance because of the key structures. In FIG. 4, some backlight zones are too bright and some backlight zones are too dark.

It is noted that the luminance values of the plural backlight zones as shown in FIG. 4 are presented herein for purpose of illustration and description only. The backlight zone A12 has the lowest luminance, e.g., 3 lumens (lm), and the two backlight zones A08 and A09 has the highest luminance, e.g., 12 lumens (lm). In the calculating process S3, the sum of the respective luminance values of the plural backlight zones A01˜A12 is divided by the number of the plural backlight zones A01˜A12, so that the overall average luminance value is obtained. That is, the overall average luminance value indicates the average luminance value of the whole light guide plate 300. In the example of FIG. 4, the overall average luminance value is about 7.833 lumens (lm). That is, (5+7+11+9+6+9+12+12+7+3+8+5)/12=7.833.

If the respective luminance values of the backlight zones A01˜A12 are higher than the overall average luminance value, it means that the backlight zones are brighter. Whereas, if the respective luminance values of the backlight zones A01˜A12 are lower than the overall average luminance value, it means that the backlight zones are darker. In accordance with a feature of the present invention, the bright levels of the light-emitting elements corresponding to the backlight zones need to be adjusted only when the preset criterion is satisfied. In an embodiment, the preset criterion is satisfied when the difference between the luminance value of a specified backlight zone and the overall average luminance value is higher than a preset difference value.

For example, the overall average luminance value is 7.833 lumens (lm), and the preset difference value is 3 lm. Under this circumstance, only the backlight zones A01 (11 lm), A08 (12 lm), A09 (12 lm) and A12 (3 lm) need to be adjusted. Since the differences between the luminance values of the other backlight zones and the overall average luminance value is not higher than 3 lm, these backlight zones do not need to be adjusted. In other words, the adjusting process is a local adjustment for adjusting the backlight zones with the very high luminance value or the very low luminance value. Consequently, the time period for calculation and adjustment is reduced, and the calculation and adjustment results can be converged.

Moreover, in the adjusting process, only the brightness levels of the light-emitting elements corresponding to the to-be-adjusted backlight zones need to be adjusted. In the example of FIG. 4, the backlight zones A01, A08, A09 and A12 need to be adjusted because they are too bright or too dark. That is, the brightness levels of the two light-emitting elements 31 and 32 corresponding to the backlight zone A01, the brightness levels of the two light-emitting elements 35 and 34 corresponding to the backlight zone A08, the brightness levels of the two light-emitting elements 35 and 36 corresponding to the backlight zone A09 and the brightness levels of the two light-emitting elements 37 and 36 corresponding to the backlight zone A12 need to be adjusted. In this embodiment, both the light-emitting elements 35 and 36 correspond to the two backlight zones that need to be adjusted.

Generally, the influences of the backlight zones on the luminance values of the keys are related to the corresponding light-emitting elements. Moreover, the influences of the backlight zones on the luminance values of the keys are also related to the light transfer in the light guide plate 300 and the overlying key structures. These factors are collaboratively defined as an optical influence coefficient. In an embodiment, each backlight zone is related to two optical influence coefficients. One of the two optical influence coefficients is related to the light-emitting element in the horizontal lateral side 30a. The other optical influence coefficient is related to the light-emitting element in the vertical lateral side 30b. All optical influence coefficients are related to the positions of the corresponding light-emitting elements and the corresponding keys.

In this context, the luminance value of each backlight zone is defined as the summation of the brightness levels of the light-emitting elements corresponding to the backlight zone multiplied by the corresponding optical influence coefficients. For example, the backlight zone A01 as shown in FIG. 4 is related to the two light-emitting elements 31 and 32. The optical influence coefficient of the backlight zone A01 corresponding to the light-emitting element 31 is C1. The optical influence coefficient of the backlight zone A01 corresponding to the light-emitting element 32 is C2. Consequently, the luminance value (e.g., 11 lm) of the backlight zone A01 may be expressed by the formula (1):

11=B1×C1+B2×C2 (1)

In the above formula, B1 and B2 are initial brightness levels of the two light-emitting elements 31 and 32, respectively. Moreover, B2 is equal to B1. In case that the spacing distance between the light-emitting element and the backlight zone is identical, the corresponding optical influence coefficient is identical. The spacing interval is the shortest distance between the light-emitting element (i.e., the corresponding lateral side) and the corresponding backlight zone. The optical influence coefficient C1 of the backlight zone A01 is equal to the optical influence coefficient C2 of the backlight zone A01 because the two light-emitting elements 31 and 32 are directly contacted with the backlight zone A01. Since the luminance value B1 (i.e., B2) is known according to the settings, the optical influence coefficient C1 or C2 is obtained through the formula (1). That is, C1 is 5.5/B1.

The backlight zone A02 as shown in FIG. 4 is related to the two light-emitting elements 31 and 34. The optical influence coefficient of the backlight zone A02 corresponding to the light-emitting element 31 is C3. The optical influence coefficient of the backlight zone A02 corresponding to the light-emitting element 34 is C4. Consequently, the luminance value (e.g., 7 lm) of the backlight zone A02 may be expressed by the formula (2):

7=B1×C3+B4×C4 (2)

In the above formula, B1 and B4 are initial brightness levels of the two light-emitting elements 31 and 34, respectively. Moreover, B4 is equal to B1 (i.e., B2). In case that the spacing distance between the light-emitting element and the backlight zone is identical, the corresponding optical influence coefficient is identical. Consequently, the optical influence coefficient C4 of the backlight zone A02 and the optical influence coefficient C2 of the backlight zone A01 are equal because the distance between the light-emitting element 34 and the backlight zone A02 is equal to the distance between the light-emitting element 32 and the backlight zone A01. Since the luminance value B1 (i.e., B2) is known and the optical influence coefficient C1 (i.e., C2 and C4) is obtained through the formula (1), the optical influence coefficient C3 is obtained. That is, C3 is 1.5/B1.

The rest may be deduced by analogy. That is, all of the optical influence coefficients can be obtained according to the similar calculations. The calculating process S3 comprises the following steps. Firstly, the luminance value of each backlight zone is defined as the summation of the brightness levels of the light-emitting elements corresponding to the backlight zone multiplied by corresponding optical influence coefficients. Then, all of the optical influence coefficients are calculated according to the known brightness levels of the light-emitting elements and the luminance values of the plural backlight zones. After all of the optical influence coefficients are calculated, the influences of the light-emitting elements on the corresponding keys are quantitated and provided for the subsequent adjustment.

The adjusting process S4 comprises the following steps. In case that a specified backlight zone satisfies the preset criterion, a compensation luminance value is obtained by subtracting the overall average luminance value from the luminance value of the specified backlight zone. Then, the brightness levels of the light-emitting elements corresponding to the specified backlight zone are increased or decreased according to the compensation luminance value and the optical influence coefficients. The compensation luminance value may be positive or negative. The positive compensation luminance value indicates that the luminance value of the specified backlight zone is higher than the overall average luminance value. The negative compensation luminance value indicates that the luminance value of the specified backlight zone is lower than the overall average luminance value. In other words, the target luminance value of the specified backlight zone is the overall average luminance value.

In the example of FIG. 4, the compensation luminance value of the backlight zone A01 is about 3.167 lm, i.e. 11−7.833=3.167. For decreasing the luminance value of the backlight zone A01 from the initial luminance value (i.e., 11 lm) according to the compensation luminance value (i.e., about 3.167 lm), the above formula (1) is rewritten to the following formula (3):

7.833=B1′×C1+B2′×C2 (3)

According to the comparison between the formula (1) and the formula (3), there are some possible approaches of decreasing the brightness levels of the light-emitting elements 31 and 32. In an embodiment, the initial brightness level B1 is kept unchanged, i.e., B1′=B1, and the initial brightness level B2 is decreased to a new brightness level B2′. In another embodiment, the initial brightness level B2 is kept unchanged, i.e., B2′=B2, and the initial brightness level B1 is decreased to a new brightness level B1′. For example, B1′ is equal to about 0.4242×B1. In another embodiment, the initial brightness level B1 is slightly decreased to a new brightness level B1′, and the initial brightness level B2 is slightly decreased to a new brightness level B2′. Moreover, the optimal decreases of the brightness levels of the light-emitting elements 31 and 32 can be calculated.

In the above example, the method for adjusting the luminance value of the backlight zone A01 with a higher initial luminance value has been described. The similar method may be applied to any backlight zone whose luminance value is required to be adjusted. For example, the backlight zone with the higher luminance value (e.g., the backlight zone A08 or A09) or the backlight zone with the lower luminance value (e.g., the backlight zone A12) can be adjusted by using the above method.

However, when the luminance value of one backlight zone is adjusted by using the above method, the luminance values of the neighboring backlight zones are possibly changed. The reason is that the light-emitting elements corresponding to the adjusted backlight zones are also the light sources of the neighboring backlight zones. For example, while the brightness levels of the light-emitting elements 31 and 32 corresponding to the backlight zone A01 are adjusted, the three backlight zones A04, A07 and A10 in the horizontal direction and the two backlight zones A02 and A03 in the vertical direction are also influenced. For minimizing the influences, the detecting process S2, the calculating process S3 and adjusting process S4 are repeatedly performed.

If the influence on the neighboring backlight zone is very large after the previous adjustment (e.g., the difference between the luminance value and the overall average luminance value is higher than the preset difference value), the processes S2, S3 and S4 are repeatedly performed to perform the subsequent adjustment. As the number of times of repeatedly performing the processes S2, S3 and S4 is increased, the target luminance value is closer to the overall average luminance value without causing the divergence problem. That is, the influences on the backlight zones with very high luminance values or very low luminance values can be effectively reduced, and the problem of generating the complicated and divergent results is avoided.

As mentioned above, the backlight adjustment is a local backlight adjustment. That is, only the backlight zones complying with the preset criterion need to be adjusted, and it is not necessary to adjust all of the backlight zones. For saving the operating time or advoiding the divergent problem, the processes S2, S3 and S4 are ended when a terminating condition is satisfied. For example, the backlight adjusting method of the present invention further comprises a step of stopping repeatedly performing the detecting process, the calculating process and the adjusting process when the number of times of repeatedly performing the detecting process, the calculating process and the adjusting process reaches a preset count value.

Generally, plural backlight zones (e.g., A01, A08, A09 and A12) are simultaneously adjusted whenever the adjusting process S4 is performed. If other backlight zones need to be adjusted after the first adjustment, a second adjustment is performed. For example, the preset count value is 2. Consequently, even if some backlight zones need to be adjusted after the second adjustment is performed, the backlight adjusting method has to be ended.

In the above embodiment, the terminating condition is satisfied when the number of times of repeatedly performing the detecting process, the calculating process and the adjusting process reaches the preset count value. It is noted that the terminating condition is not restricted. For example, in another embodiment, the detecting process, the calculating process and the adjusting process are not repeatedly performed and the purpose of obtaining uniform luminance of the backlight keyboard is achieved when the terminating condition is satisfied. After the detecting process is repeatedly performed, a uniformity and a local contrast of the plural backlight zones are calculated. If the uniformity is larger than a uniformity threshold value and/or the local contrast is not beyond a contrast threshold range, the detecting process, the calculating process and the adjusting process are not repeatedly performed.

The definition of the uniformity may be different in different field (e.g., the displaying field or the backlight keyboard field). In accordance with the present invention, the term “uniformity” indicates the result of the division of the lowest luminance value by the highest luminance value among the backlight zones A01˜A12. In the example of FIG. 4, the lowest luminance value is 3 lm, and the highest luminance value is 12 lm. Consequently, the uniformity of FIG. 4 is 25% (i.e., 3/12=25%).

In an embodiment, the uniformity threshold value is 33%. Since the uniformity in the example of FIG. 4 is lower than the uniformity threshold value, it is necessary to perform the adjustment again. That is, the uniformity of the backlight zones A01˜A12 is still unsatisfied, and the subsequent backlight adjustment is needed.

Similarly, the definition of the local contrast may be different in different field (e.g., the displaying field or the backlight keyboard field). In accordance with the present invention, the term “local contrast” indicates the result of the division of the difference between the luminance value of any backlight zone and a local average luminance value of the backlight zones in a local area by the highest luminance value among the backlight zones in the local area. In the example of FIG. 4, a local area contains four backlight zones A08, A09, A11 and A12. The local average luminance value of these backlight zones is 8.75, i.e., (12+12+3+8)/4=8.75. Consequently, the local contrast of the backlight zone A12 is about −48%, i.e., (3−8.75)/12=−48%.

In an embodiment, the contrast threshold range is between −50% and +50%. In the example of FIG. 4, the local contrast of the backlight zone A12 (−48%) is within the contrast threshold range. That is, the local contrast among these backlight zones A08, A09, A11 and A12 is acceptable. Consequently, it is not necessary to perform the subsequent adjustment.

Preferably, the process of judging the uniformity and/or the local contrast is performed in a detecting process after at least one adjusting process is completed. Of course, the timing of judging the uniformity and/or the local contrast may be determined according to the practical requirements. In an embodiment, both of the uniformity and the local contrast are judged. Alternatively, one of the uniformity and the local contrast is judged. Moreover, the uniformity threshold value and the contrast threshold range may be varied according to the practical requirements. Generally, the backlight keyboard is used for increasing the uniformity of all backlight zones and reducing the bright/dark contrast of different backlight zones.

In the above embodiments, the plural light-emitting elements (e.g., LEDs) are located beside two lateral sides 30a and 30b of the light guide plate 300. Consequently, the backlight zones A01˜A12 are arranged in an array. It is noted that numerous modifications and alterations may be made while retaining the teachings of the invention.

In a variant example, the plural light-emitting elements are located beside three or four lateral sides of the light guide plate in order to increase the overall luminance value. The optical influence coefficients corresponding to the light-emitting elements at more lateral sides of the light guide plate may be obtained by using the above method. The optical influence coefficients may be obtained by using a simpler method because the number of keys or backlight zones far away the corresponding light-emitting elements is reduced. Since the optical influence coefficients of the backlight zones corresponding to the closer light-emitting elements are calculated, the formula is more flexible.

In the above embodiments, the backlight adjusting method is used for adjusting the luminance value of the backlight zone that is too bright or too dark. It is noted that numerous modifications and alterations may be made while retaining the teachings of the invention.

In a variant example, the luminance value of the backlight keyboard can be adjusted by the user. Alternatively, the local luminance value is changeable according to the practical requirements. Consequently, the operating flexibility is enhanced. In the above embodiment, the luminance value of the backlight keyboard is adjusted through the detecting machine. It is noted that numerous modifications and alterations may be made while retaining the teachings of the invention. In some embodiments, the computer has the hardware component for the backlight keyboard, and the backlight adjusting method is implemented when a firmware component or a software component installed in the computer is executed.

In the detecting process, the initial luminance values of all backlight zones are detected by the computer. Particularly, the backlight zones are considered to have the same initial luminance value. If an application program is executed to implement a specified function, one or more specified backlight zones of the backlight keyboard corresponding to the execution of the specified function satisfy the preset criterion. For example, if the user intends to input a numeric interface or a display window via the backlight keyboard, the keys corresponding to the numeric keypad of the backlight keyboard are highlighted to prompt the user.

That is, only the luminance value of a specified area of the backlight keyboard is increased, and the luminance values of all backlight zones are not adjusted to be uniform. Since all of the backlight zones are considered to have the same initial luminance value and the overall average luminance value is equal to the initial luminance value, the calculation is simplified and it is not necessary to obtain the optical influence coefficients. That is, only the luminance values of the backlight zones corresponding to the specified area of the backlight keyboard need to be adjusted (e.g., increased or decreased). When the preset criterion is no longer satisfied, the brightness levels of the corresponding light-emitting elements are adjusted to the initial brightness levels.

From the above descriptions, the present invention provides a backlight keyboard with a backlight adjusting function, a backlight adjusting system and a backlight adjusting method. The technologies of the present invention are capable of solving the problem of non-uniform illumination or non-uniform transmittance. The adjustment of the brightness levels of the light-emitting elements (e.g., LEDs) can achieve the object of the present invention without the need of re-designing the light guide plate according to the screen printing process. Moreover, according to the practical requirements, the illuminating status is changed. Consequently, the use flexibility is enhanced.

Moreover, the technologies of the present invention can effectively reduce the development cost and the maintenance cost and bring enhanced operating flexibility to the user. In other words, the technologies of the present invention are competitive and effective to overcome the drawbacks of the conventional technologies.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A backlight adjusting method for a backlight keyboard, the backlight keyboard comprising a keyboard portion and a backlight module, the keyboard portion comprising plural keys, the backlight module comprising a light guide plate and plural light-emitting elements, the plural light-emitting elements being located beside at least two lateral sides of the light guide plate, the backlight adjusting method comprising steps of:
performing an initiation process to allow the plural light-emitting elements to emit light beams, so that plural backlight zones corresponding to the plural keys are formed on the light guide plate;
performing a detecting process to detect respective luminance values of the plural backlight zones;
performing a calculating process to calculate an overall average luminance value of the plural backlight zones;
performing an adjusting process, wherein if a preset criterion is satisfied, brightness levels of the light-emitting elements corresponding to the backlight zones are adjusted according to the luminance values of the backlight zones and the overall average luminance value; and
repeatedly performing the detecting process, the calculating process and the adjusting process.

2. The backlight adjusting method according to claim 1, wherein when a firmware component or a software component stored in a memory of a detecting machine is executed, the backlight adjusting method is implemented and applied to the backlight keyboard.

3. The backlight adjusting method according to claim 2, wherein in the detecting process, the respective luminance values of the plural backlight zones are detected by a luminance sensor of the detecting machine.

4. The backlight adjusting method according to claim 1, wherein in the calculating process, the sum of the respective luminance values of the plural backlight zones is divided by a number of the plural backlight zones, so that the overall average luminance value is obtained.

5. The backlight adjusting method according to claim 1, wherein the brightness levels of the plural light-emitting elements in the initiation process are equal, and the calculating process further comprises steps of:
obtaining the luminance value of each backlight zone, wherein the luminance value of the backlight zone is defined as the summation of the brightness levels of the light-emitting elements corresponding to the backlight zone multiplied by corresponding optical influence coefficients, and the optical influence coefficients are related to positions of the corresponding light-emitting elements and the corresponding keys; and
calculating all of the optical influence coefficients,
wherein if a spacing distance between a first light-emitting element of the plural light-emitting elements and the corresponding backlight zone is equal to a spacing distance between a second light-emitting element of the plural light-emitting elements and the corresponding backlight zone, the optical influence coefficient corresponding to the first light-emitting element and the optical influence coefficient corresponding to the second light-emitting element are equal.

6. The backlight adjusting method according to claim 5, wherein the adjusting process comprises steps of:
if a specified backlight zone of the plural backlight zones satisfies the preset criterion, obtaining a compensation luminance value by subtracting the overall average luminance value from the luminance value of the specified backlight zone; and
increasing or decreasing the brightness levels of the light-emitting elements corresponding to the specified backlight zone according to the compensation luminance value and the corresponding optical influence coefficients.

7. The backlight adjusting method according to claim 1, wherein if a difference between the luminance value of a specified backlight zone of the plural backlight zones and the overall average luminance value is higher than a preset difference value, the specified backlight zone of the plural backlight zones satisfies the preset criterion.

8. The backlight adjusting method according to claim 1, wherein if an application program is executed to implement a specified function, a specified backlight zone of the backlight keyboard corresponding to the execution of the specified function satisfies the preset criterion.

9. The backlight adjusting method according to claim 1, further comprising a step of stopping repeatedly performing the detecting process, the calculating process and the adjusting process when a number of times of repeatedly performing the detecting process, the calculating process and the adjusting process reaches a preset count value.

10. The backlight adjusting method according to claim 1, further comprising a step of calculating a uniformity and a local contrast of the plural backlight zones after the detecting process is repeatedly performed, wherein if the uniformity is larger than a uniformity threshold value and/or the local contrast is not beyond a contrast threshold range, the detecting process, the calculating process and the adjusting process are not repeatedly performed.

11. The backlight adjusting method according to claim 10, wherein the uniformity indicates the result of the division of the lowest luminance value by the highest luminance value among the plural backlight zones, and the uniformity threshold value is 33%.

12. The backlight adjusting method according to claim 10, wherein the local contrast indicates the result of the division of the difference between the luminance value of any backlight zone and a local average luminance value of the backlight zones in a local area by the highest luminance value among the backlight zones in the local area, and the contrast threshold range is between −50% and +50%.

13. The backlight adjusting method according to claim 1, wherein the plural backlight zones are arranged in an array.

14. A backlight keyboard with a backlight adjusting function, the backlight keyboard comprising:
a keyboard portion comprising plural keys; and
a backlight module disposed on a backside of the keyboard portion, and comprising a light guide plate and plural light-emitting elements, wherein the plural light-emitting elements are located beside at least two lateral sides of the light guide plate, and the plural light-emitting elements emit light beams in an initiation process, so that plural backlight zones corresponding to the plural keys are formed on the light guide plate,
wherein respective luminance values of the plural backlight zones are detected in a detecting process, and an overall average luminance value of the plural backlight zones is calculated in a calculating process, wherein if a preset criterion is satisfied, brightness levels of the light-emitting elements corresponding to the backlight zones are adjusted in an adjusting process according to the luminance values of the backlight zones and the overall average luminance value, wherein the detecting process, the calculating process and the adjusting process are repeatedly performed.

15. The backlight keyboard according to claim 14, wherein when a firmware component or a software component stored in a memory of a detecting machine is executed, the initiation process, the detecting process, the calculating process and the adjusting process are implemented and applied to the backlight keyboard.

16. A backlight adjusting system, comprising:
a backlight keyboard comprising a keyboard portion and a backlight module, wherein the backlight module is disposed on a backside of the keyboard portion, and the keyboard portion comprises plural keys; and
a detecting machine applied to the backlight keyboard,
wherein the backlight module comprises a light guide plate and plural light-emitting elements, wherein the plural light-emitting elements are located beside at least two lateral sides of the light guide plate, and the plural light-emitting elements emit light beams in an initiation process, so that plural backlight zones corresponding to the plural keys are formed on the light guide plate,
wherein respective luminance values of the plural backlight zones are detected in a detecting process, and an overall average luminance value of the plural backlight zones is calculated in a calculating process, wherein if a preset criterion is satisfied, brightness levels of the light-emitting elements corresponding to the backlight zones are adjusted in an adjusting process according to the luminance values of the backlight zones and the overall average luminance value, wherein the detecting process, the calculating process and the adjusting process are repeatedly performed.

17. The backlight adjusting system according to claim 16, wherein when a firmware component or a software component stored in a memory of the detecting machine is executed, the initiation process, the detecting process, the calculating process and the adjusting process are implemented and applied to the backlight keyboard.

18. The backlight adjusting system according to claim 16, wherein the detecting machine comprises a luminance sensor, and the respective luminance values of the plural backlight zones are detected by the luminance sensor in the detecting process.
